(19) United States
(12) Patent Application Publication
(10) Pub. No.: US 2019/0383335 A1
(43) Pub. Date: Dec. 19, 2019

(54) ROBOT CONTROL DEVICE AND ROBOT PROVIDED WITH THE SAME

(71) Applicant: KAWASAKI JUKOGYO KABUSHIKI KAISHA, Kobe-shi, Hyogo (JP)

(72) Inventor: Tsuyoshi TAGASHIRA, Kakogawa-shi (JP)

(73) Assignee: KAWASAKI JUKOGYO KABUSHIKI KAISHA, Kobe-shi, Hyogo (JP)

(21) Appl. No.: 16/464,313

(22) PCT Filed: Nov. 24, 2017
(86) PCT No.: PCT/JP2017/042164

§ 371 Date: May 28, 2019

(30) Foreign Application Priority Data
Nov. 25, 2016 (JP) 2016-228899

(51) Int. Cl. F16D 27/00; H02P 15/00

(52) U.S. Cl. CPC F16D 27/004; H02P 15/00

(57) ABSTRACT

A robot control device has a drive shaft driven by a servo motor including a non-excited operation type electromagnetic brake, wherein, in a brake release state of the non-excited operation type electromagnetic brake, energization ON and energization OFF of an exciting coil of the non-excited operation type electromagnetic brake are alternately repeated, and at that time at least the timing of the energization ON is deviated between a plurality of exciting coils. It is possible to realize heat generation suppression/energy saving while suppressing generation of noise in the non-excited operation type electromagnetic brake of the robot.

### TECHNICAL FIELD

The present invention relates to a robot control device for controlling a robot provided with a servo motor with a non-excited operation type electromagnetic brake and a robot provided with the control device.

### BACKGROUND ART

A servo motor used for a drive shaft of an arm or the like of a robot, especially an industrial robot is generally provided with a non-excited operation type electromagnetic brake (hereunder, it may be referred to simply as “brake”) in order to prevent runaway or the like upon power loss during operation in addition to certainty of retention of the position at the time of stoppage.

In the non-excited operation type electromagnetic brake, an exciting coil, a spring, an armature and a friction plate are arranged in a line in this order, and when the exciting coil is de-energized, it performs brake operation by pressing the armature against the friction plate by the urging force of the spring, and when the exciting coil is energized, it releases the brake operation state by attracting the armature against the urging force of the spring and pulling it away from the friction plate.

Here, in the non-excited operation type electromagnetic brake, it has been found that it is not always necessary to maintain the energized state of the exciting coil all the time after the exciting coil is energized and the armature is pulled away from the friction plate to be in a brake release position.

That is, after the exciting coil is energized and the armature is pulled away from the friction plate to be in a brake release position, the brake release state can be maintained even if energization of the exciting coil is stopped if in a short time. Note that, the possible energization stop time at which a brake release state can be maintained changes with specifications of the brake.

In Patent Document 1, taking advantage of the above characteristics of the non-excited operation type electromagnetic brake, in order to suppress heat generation due to energization of the exciting coil in the brake release state, a technique is proposed for ON-OFF control of power supply to the exciting coil in the brake release state.

### CITATION LIST

### Patent Document

[Patent Document 1] Japanese Patent Application Laid-open No. 2013-67009

### SUMMARY OF INVENTION

### Objects to be Achieved by the Invention

Here, since noise is generated when starting to energize the exciting coil (energization ON) and cutting of the energization of the exciting coil (energization OFF), it is necessary to reduce the influence of this noise on peripheral devices as much as possible. Note that, usually, larger noise is generated at the time of energization ON than at the time of energization OFF.

With regard to the problem of noise, in the technique of Patent Document 1, the energization ON and the energization OFF of the exciting coil in the brake release state are simultaneously performed in the brakes of all the drive shafts. Therefore, noise is generated simultaneously in all the brakes, and adverse effects on peripheral devices become significant.

That is, in the technique of Patent Document 1, although the effect of heat generation suppression/energy saving can be expected by performing ON/OFF control of energization of the exciting coil in the brake release state, a new problem arises that the noise generated at the time of ON/OFF control adversely affects peripheral devices.

The present invention is made considering the above-mentioned problems of the conventional technique, and its object is to provide a robot control device capable of realizing heat generation suppression/energy saving while suppressing generation of noise in a non-excited operation type electromagnetic brake of a robot, and a robot provided with the control device.

### Means for Achieving the Objects

In order to achieve the above-mentioned objects, a first aspect of the present invention is a robot control device having a drive shaft driven by a servo motor including a non-excited operation type electromagnetic brake, wherein, in a brake release state of the non-excited operation type electromagnetic brake, an energization ON and an energization OFF of an exciting coil of the non-excited operation type electromagnetic brake are alternately repeated, and at that time at least a timing of the energization ON is deviated between a plurality of the exciting coils.

A second aspect of the present invention is that, in the first aspect, both a timing of the energization ON and a timing of the energization OFF are deviated between a plurality of the exciting coils.

A third aspect of the present invention is that, in the first or second aspect, a ON/OFF ratio of the energization ON and the energization OFF is modulated.

A fourth aspect of the present invention is that, in the third aspect, the ON/OFF ratio is modulated randomly.

A fifth aspect of the present invention is that, in any one of the first to fourth aspects, a switching frequency of the energization ON and the energization OFF is modulated.

A sixth aspect of the present invention is that, in the fifth aspect, the switching frequency is modulated randomly.

A seventh aspect of the present invention is a robot comprising: a robot control device according to any one of the first to sixth aspects; and a drive shaft controlled by the robot control device.

### Effect of the Invention

According to the present invention, there can be provided a robot control device capable of realizing heat generation suppression/energy saving while suppressing generation of noise in a non-excited operation type electromagnetic brake of a robot, and a robot provided with the control device.

### BRIEF DESCRIPTION OF THE DRAWINGS

FIG. 1 is a diagram schematically illustrating a brake system in a robot provided with a robot control device according to one embodiment of the present invention.

FIG. 2 is a diagram illustrating a voltage signal applied to the exciting coil in the brake system illustrated in FIG. 1.

FIG. 3 is a diagram illustrating an example of the voltage signal applied to the exciting coil in the brake system illustrated in FIG. 1.

FIG. 4 is a diagram illustrating another example of the voltage signal applied to the exciting coil in the brake system illustrated in FIG. 1.

### EMBODIMENT OF THE INVENTION

Hereunder, a robot control device according to one embodiment of the present invention and a robot provided with the control device will be described referring to the drawings.

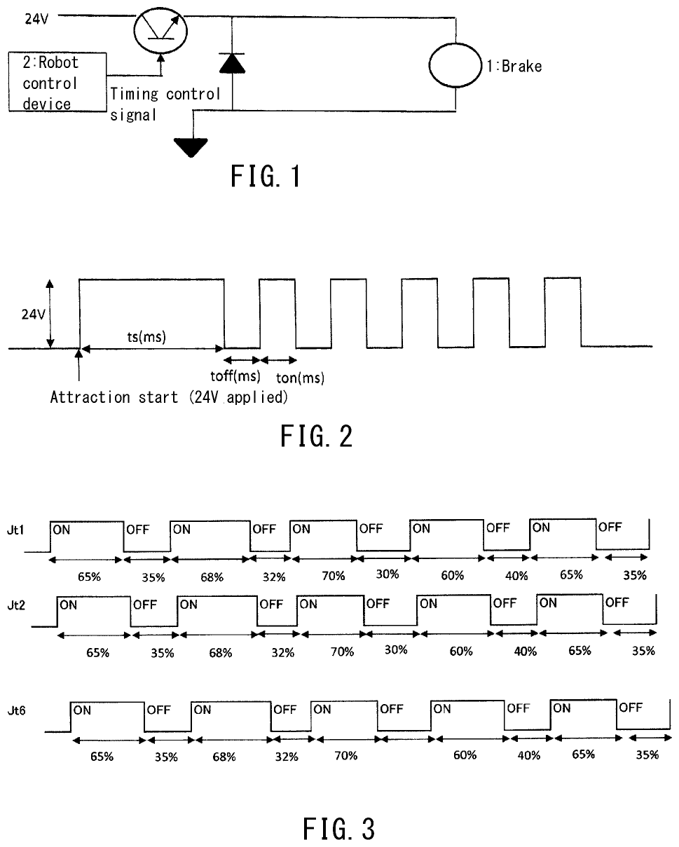

As illustrated in FIG. 1, the brake system in the robot according to this embodiment is provided an non-excited operation type electromagnetic brake 1 incorporated in a servo motor. In this brake system, the switching operation is performed by supplying a timing control signal from a robot control device 2 to the switching element to which a predetermined voltage (24V in this example) is supplied, thereby switching between the energization ON state and the energization OFF state of the exciting coil of the brake 1.

Note that, in this embodiment, the attraction time ts (ms) illustrated in FIG. 1, the voltage application DUTY after attraction (%), and the frequency can be arbitrarily set in accordance with the motor characteristics (attraction time, release time, and the like.)

In the non-excited operation type electromagnetic brake 1 in this example, as described in the section of the conventional technique, the exciting coil, the spring, the armature, and the friction plate are arranged in a line in this order, and the armature is pressed against the friction plate by the biasing force of the spring when the exciting coil is not energized so as to perform the brake operation. Then, when the exciting coil is energized, the armature is attracted to the exciting brake side against the biasing force of the spring and pulled away from the friction plate so as to release the brake operation. Note that, the non-excited operation type electromagnetic brake 1 is provided to each of a plurality of drive shafts of the robot.

When switching the non-excited operation type electromagnetic brake 1 to the brake release state, the switching element is made conductive by the timing control signal from the robot control device 2, and as illustrated in FIG. 2, a predetermined voltage (24V in this example) is applied to the exciting coil of the brake 1 to attract the armature and pull it away from the friction plate, thereby releasing the brake operating state.

As already described, in the non-excited operation type electromagnetic brake 1, it is not always necessary to maintain the energized state of the exciting coil all the time after the armature is pulled away from the friction plate to be in the brake release position.

Accordingly, in this embodiment, in order to suppress energy consumption and heat generation due to the energization of the exciting coil in the brake release state, once the brake release state is achieved, the energization of the exciting coil is controlled to be ON and OFF as illustrated in FIG. 2. By alternately repeating the energization ON and OFF of the exciting coil in the brake release state as described above, energy consumption is suppressed as compared with the case where the energization is ON all the time and energy saving effect is obtained, and also the temperature rise inside the robot arm can be suppressed.

For example, in the case of 50% DUTY (ON/OFF ratio), 12V is applied, and when the current is 0.33 A, 12V×0.33 A×0.5=1.98(w) is obtained, where a large energy saving effect can be obtained compared with the case where 24V is constantly applied (24V×0.33 A=7.92 W).

Further, in this embodiment, in order to suppress an adverse effect on peripheral devices caused by noise generated by ON/OFF control of energization of the exciting coil, the following measures are taken.

Specifically, in this embodiment, in the brake release state of the non-excited operation type electromagnetic brake 1, when alternately repeating the energization ON and OFF of the exciting coil in the brake 1, the timing of energization ON and the timing of energization OFF are deviated between a plurality of exciting coils provided on a plurality of drive shafts. It is preferable that the timing of energization ON and the timing of energization OFF are deviated between the plurality of exciting coils at every timing.

FIG. 3 is a diagram illustrating an example of a voltage signal applied to the exciting coil in the brake release state in the brake system illustrated in FIG. 1. In this example, as illustrated in FIG. 3, the timing of energization ON and the timing of energization OFF are deviated between three exciting coils of three drive shafts (Jt1, Jt2, Jt3) of the robot.

In this example, with the above configuration, the timings of energization ON and energization OFF of the plurality of exciting coils in the brake release state differ for each exciting coil, so the timings of noise generation during the ON/OFF operation differ for each exciting coil. Therefore, the simultaneous generation of noise can be avoided to suppress the adverse effect of noise on peripheral devices.

Furthermore, in the example illustrated in FIG. 3, the ON/OFF ratio (DUTY) of energization ON and energization OFF is randomly modulated with a constant cycle. Thereby, it can be expected that the spread spectrum effect of harmonic noise is increased.

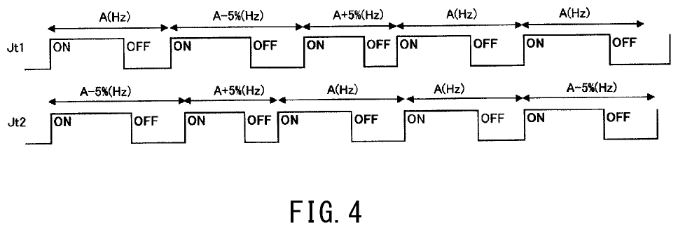

As another example of the voltage signal applied to the exciting coil in the brake release state, as illustrated in FIG. 4, the switching frequency of energization ON and energization OFF may be randomly modulated.

Also in this example, the timings of energization ON and energization OFF of the plurality of exciting coils in the brake release state differ for each exciting coil, so the timings of noise generation during the ON/OFF operation differ for each exciting coil. Therefore, the simultaneous generation of noise can be avoided to suppress the adverse effect of noise on peripheral devices.

Note that, although the ON/OFF ratio is fixed in the example illustrated in FIG. 4, as a variation, the switching frequency of energization ON and energization OFF may be randomly modulated, and the ON/OFF ratio may also be modulated randomly. Thereby, it can be expected that the spread spectrum effect of harmonic noise is increased.

As described above, according to the robot control device and the robot provided with the control device in the above embodiment, it is possible to suppress energy consumption and heat generation in the exciting coil in the brake release state, and also it is possible to suppress an adverse effect on peripheral devices due to noise generated with the ON/OFF operation.

### DESCRIPTION OF REFERENCE NUMERALS

1 . . . brake
2 . . . robot control device

1. A robot control device for a robot having a drive shaft driven by a servo motor including a non-excited operation type electromagnetic brake,
wherein, in a brake release state of the non-excited operation type electromagnetic brake, an energization ON and an energization OFF of an exciting coil of the non-excited operation type electromagnetic brake are alternately repeated, and at that time at least a timing of the energization ON is deviated between a plurality of the exciting coils.

2. The robot control device according to claim 1,
wherein both the timing of the energization ON and a timing of the energization OFF are deviated between a plurality of the exciting coils.

3. The robot control device according to claim 1,
wherein a ON/OFF ratio of the energization ON and the energization OFF is modulated.

4. The robot control device according to claim 3,
wherein the ON/OFF ratio is modulated randomly.

5. The robot control device according to claim 1.
wherein a switching frequency of the energization ON and the energization OFF is modulated.

6. The robot control device according to claim 5,
wherein the switching frequency is modulated randomly.

7. A robot comprising: a robot control device according to claim 1; and a drive shaft controlled by the robot control device.
